(19) United States
(12) Patent Application Publication
(10) Pub. No.: US 2025/0077447 A1
(43) Pub. Date: Mar. 6, 2025

(54) SYSTEMS AND METHODS FOR BALANCING MEMORY SPEEDS

(71) Applicant: SMART Modular Technologies, Inc., Newark, CA (US)

(72) Inventors: Torry Steed, Poway, CA (US); Andrew Mills, Coto de Caza, CA (US)

(21) Appl. No.: 18/238,826

(22) Filed: Aug. 28, 2023

(51) Int. Cl. G06F 13/16; G06F 13/22; G06F 13/42

(52) U.S. Cl. CPC G06F 13/1689; G06F 13/22; G06F 13/4221

(57) ABSTRACT

Systems and methods for balancing memory speeds are disclosed. In particular, at start up, a host to memory bus speed is determined and compared to a default internal memory device bus speed. A memory device control circuit may then determine if an internal bus should be overclocked or slowed down to match the host to memory bus speed. The selection may then be stored in a register and made available to a host memory controller (e.g., through polling or the like). Selection of an internal speed may also be based on other factors such as power savings or the like. In either event, having the flexibility to set the internal speed based on one or more such criteria may result in improved efficiency.

### BACKGROUND

### I. Field of the Disclosure

The technology of the disclosure relates generally to memory devices and, and more particularly, to memory devices that may have internal speeds that do not match the bus speeds.

### II. Background

Computing devices abound in modern society. The prevalence of these devices is driven in part by the many functions that are now enabled on such devices. Increased processing capabilities in such devices enable enhanced user experiences. With the advent of the myriad functions available to such devices, the size and complexity of the operating systems used to control computing devices have increased. Likewise, there is a general trend for increasingly large and complex software applications. This increase in size and complexity requires more available memory to support the host processor. Most computing devices have a motherboard with limited space for memory devices and/or a limited number of slots which may be used for myriad purposes, including a memory device. Since the use of such a slot involves trade-offs with other possible uses, there has been pressure to increase the amount of memory that may be accessed through such a slot. One such solution has been through the use of a compute express link (CXL), which may operate through a peripheral component interconnect express (PCIe) serial expansion bus. Standard CXL options may not fully utilize the bandwidth available on the PCIe bus. Accordingly, there is room for innovation when faced with such bandwidth mismatches.

### SUMMARY

Aspects disclosed in the detailed description include systems and methods for balancing memory speeds. In an exemplary aspect, at start-up, a host to memory bus speed is determined and compared to a default internal memory device bus speed. A memory device control circuit may then determine if an internal bus should be overclocked or slowed down to match the host to memory bus speed. The selection may then be stored in a register and made available to a host memory controller (e.g., through polling or the like). Selection of an internal speed may also be based on other factors, such as power savings or the like. In either event, having the flexibility to set the internal speed based on one or more such criteria may result in improved efficiency.

In this regard, in one aspect, a memory device is disclosed. The memory device includes an external bus interface configured to couple to a bus having a first speed, an internal bus, and a memory circuit coupled to the internal bus and having a second speed. The memory device further includes a control circuit coupled to the internal bus and the external bus interface, the control circuit configured to compare the first speed to the second speed and change the second speed to match approximately the first speed.

In another aspect, a method of balancing speeds for a memory device is disclosed. The method includes determining a first speed associated with an external bus coupled to the memory device and determining a second speed associated with a memory circuit in the memory device. The method further includes changing the second speed to match approximately the first speed.

### BRIEF DESCRIPTION OF THE DRAWINGS

FIG. 1 is a block diagram of an exemplary computing device having a processor and volatile memory devices including one that may be accessed through an external memory bus;

FIG. 2 is a block diagram including alternate details of the external memory device; and

FIG. 3 is a flowchart showing how speed balancing is done between the external memory bus and the internal memory bus.

### DETAILED DESCRIPTION

The embodiments set forth below represent the necessary information to enable those skilled in the art to practice the embodiments and illustrate the best mode of practicing the embodiments. Upon reading the following description in light of the accompanying drawing figures, those skilled in the art will understand the concepts of the disclosure and will recognize applications of these concepts not particularly addressed herein. It should be understood that these concepts and applications fall within the scope of the disclosure and the accompanying claims.

It will be understood that although the terms first, second, etc. may be used herein to describe various elements, these elements should not be limited by these terms. These terms are only used to distinguish one element from another. For example, a first element could be termed a second element, and similarly, a second element could be termed a first element without departing from the scope of the present disclosure. As used herein, the term “and/or” includes any and all combinations of one or more of the associated listed items.

It will be understood that when an element such as a layer, region, or substrate is referred to as being “on” or extending “onto” another element, it can be directly on or extend directly onto the other element, or intervening elements may also be present. In contrast, when an element is referred to as being “directly on” or extending “directly onto” another element, no intervening elements are present. Likewise, it will be understood that when an element such as a layer, region, or substrate is referred to as being “over” or extending “over” another element, it can be directly over or extend directly over the other element or intervening elements may also be present. In contrast, when an element is referred to as being “directly over” or extending “directly over” another element, no intervening elements are present. It will also be understood that when an element is referred to as being “connected” or “coupled” to another element, it can be directly connected or coupled to the other element, or intervening elements may be present. In contrast, when an element is referred to as being “directly connected” or “directly coupled” to another element, no intervening elements are present.

Relative terms such as “below” or “above” or “upper” or “lower” or “horizontal” or “vertical” may be used herein to describe a relationship of one element, layer, or region to another element, layer, or region as illustrated in the Figures. It will be understood that these terms and those discussed above are intended to encompass different orientations of the device in addition to the orientation depicted in the Figures.

The terminology used herein is for the purpose of describing particular embodiments only and is not intended to be limiting of the disclosure. As used herein, the singular forms “a,” “an,” and “the” are intended to include the plural forms as well unless the context clearly indicates otherwise. It will be further understood that the terms “comprises,” “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this disclosure belongs. It will be further understood that terms used herein should be interpreted as having a meaning that is consistent with their meaning in the context of this specification and the relevant art and will not be interpreted in an idealized or overly formal sense unless expressly so defined herein.

Aspects disclosed in the detailed description include systems and methods for balancing memory speeds. In an exemplary aspect, at start up, a host to memory bus speed is determined and compared to a default internal memory device bus speed. A memory device control circuit may then determine if an internal bus should be overclocked or slowed down to match the host to memory bus speed. The selection may then be stored in a register and made available to a host memory controller (e.g., through polling or the like). Selection of an internal speed may also be based on other factors such as power savings or the like. In either event, having the flexibility to set the internal speed based on one or more such criteria may result in improved efficiency.

Before addressing aspects of the present disclosure, a definition is offered. As used herein, the term double data rate or DDR is an industry term that means transferring data on the rising and falling edge of the clock signal, allowing for faster data transfer rates as compared to single data rate (SDR), which is only clocked on one edge of the clock (either rising or falling edge). As noted, DDR and SDR are terms used pervasively within the memory and computer industries.

Additionally, as used herein “approximately” means within five percent.

Further, as used herein “overclocked” is operating the memory at a higher than rated clock speed.

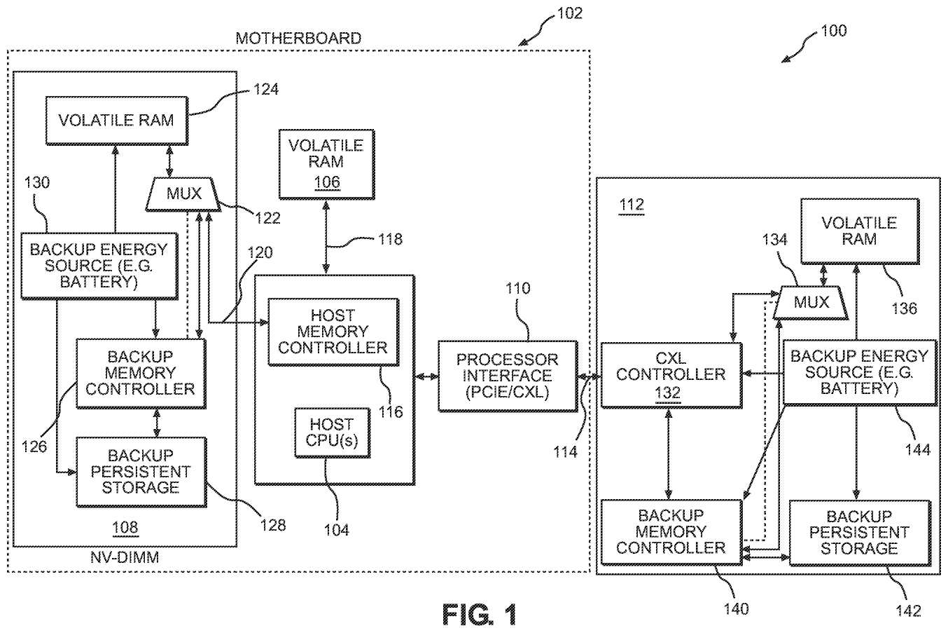

In this regard, FIG. 1 is a block diagram of a computing device 100. The computing device 100 may include a motherboard 102. The motherboard 102 may have a host processor (also sometimes referred to as a computer processing unit (CPU)) 104, a first local memory 106, and a second local memory 108. The motherboard 102 may also have a communication interface 110 that allows communication to an external memory 112 through a bus 114. In an exemplary aspect, the bus 114 may be a peripheral component interconnect express (PCIe) bus, a compute express link (CXL) bus, or a CXL protocol over a PCIe physical layer.

The host processor 104 may include a host memory controller 116 that communicates with the first local memory 106 through a first internal memory bus 118. The host memory controller 116 may further communicate with the second local memory 108 through a second internal memory bus 120. The first local memory 106 may be formed from volatile random-access memory (RAM).

The second local memory 108 may include a multiplexer (mux) 122 that provides access to a volatile RAM 124. The mux 122 also communicates with a backup memory controller 126. The backup memory controller 126 is coupled to a persistent memory 128. The persistent memory 128 may also be coupled to a backup energy source (e.g., battery) 130. At the command of the host memory controller 116 or on detection of power loss, the backup memory controller 126 may cause the information in the volatile RAM 124 to be copied into the persistent memory 128.

Similarly, the external memory 112 may have a bus interface (not shown) that sends and receives signals over the bus 114. Received signals are passed to a control circuit 132 (or the interface may be integrated into the control circuit 132) and pass through a mux 134 to a volatile RAM 136. The external memory 112 may further have a backup memory controller 140. The backup memory controller 140 may be coupled to a persistent memory 142. The persistent memory 142 may also be coupled to a backup energy source (e.g., battery) 144. At the command of the host memory controller 116 or on detection of power loss, the backup memory controller 140 may cause information in the volatile RAM 136 to be copied into the persistent memory 142.

Using CXL over PCIe as an example, it is not uncommon for bus 114 to have a speed between twelve and forty-eight gigabytes per second (12-48 GB/s). In contrast, the internal memory bus for the external memory 112 may be limited by the maximum bandwidth of the volatile RAM 136. A typical volatile RAM 136 may be made from a plurality of double data rate (DDR) version 4 (DDR4) memory sticks. DDR4 maximum bandwidth depends on the DRAM speed grade, which may be 2133-3200 megatransfers/second, which corresponds to a bus speed of 17-25.6 GB/s. While there is an overlap in speeds, it is readily apparent that there is a large range of PCIe speeds that are faster than any natural speed of the internal bus. Likewise, there is a portion of the PCIe speeds which are slower than any natural speed of the internal bus. This speed mismatch may lead to inefficiencies including extra power consumption or the like.

Exemplary aspects of the present disclosure contemplate adjusting the speed of the internal bus such as by overclocking or underclocking to balance the speeds of the two buses. Note that such balancing may be approximate, with a goal of an exact match, but recognizing that a perfect match may not be practical. In addition to balancing, there may be other criteria such as power savings which may be considered when adjusting the speed of the internal bus. It should be appreciated that one existing solution is to use a DDR5 DRAM. However, while this approach allows for a greater overlap between the bus speeds, this approach is more expensive. The increased expense may seem trivial for small amounts of memory, but as memory requirements continue to increase (particularly for applications such as graphics rendering, machine learning, artificial intelligence algorithms, or the like), this increase in cost may be commercially contraindicated.

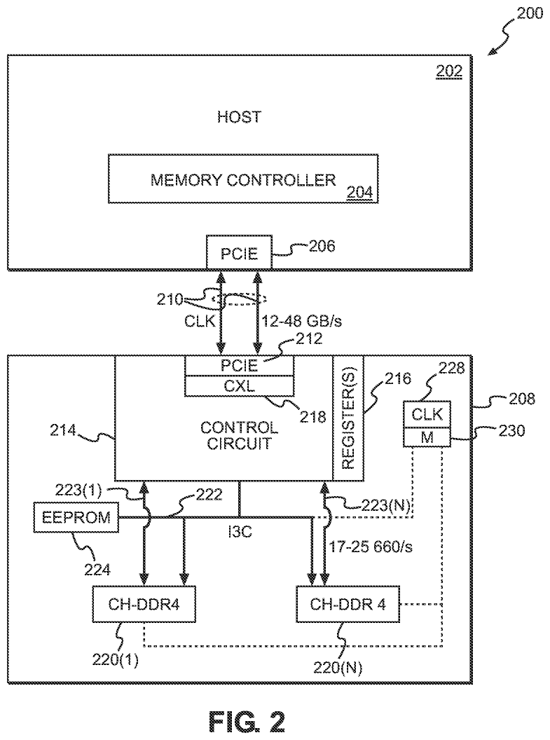

FIG. 2 provides additional details to illustrate the hardware used to effectuate this balancing. In particular, a computing device 200 may have a host 202 with a memory controller 204 and a bus interface 206. As noted above, the bus interface may be a PCIe bus interface. The host 202 is coupled to an external memory 208 through an external bus 210, which may be a PCIe bus. The bus interface 206 is configured to couple to the external bus 210. The external bus 210 may have a plurality of lanes and a clock lane configured to carry a clock signal. In an exemplary aspect, the external bus 210 may have a speed between 12-48 GB/s.

The external memory 208 may include a bus interface 212 that may be distinct or may be part of a control circuit 214 that has registers 216 associated therewith. The bus interface 212 may be a PCIe bus interface and is configured to couple to the external bus 210. There may also a CXL interface 218 associated with the bus interface 212 and the control circuit 214. The control circuit 214 communicates with volatile memory circuits 220(1)-220(N) through a management bus 222 and separate internal data buses 223(1)-223(N). In an exemplary aspect the management bus 222 is an improved inter-integrated circuit (13C) bus, the internal data buses 223(1)-223) are DDR or DRAM buses and the volatile memory circuits 220(1)-220(N) are DDR4 DRAM. While DDR4 is specifically contemplated, other memory types may benefit from the present disclosure and DDR5, DDR6 are also contemplated. An electrically erasable programmable read only memory (EEPROM) 224 may also be coupled to the management bus 222 for storing configuration data such as the results of any rebalancing such that the same settings can automatically be applied on a reset or power cycle. A clock 228 may also communicate with the control circuit 214, the management bus 222, and the volatile memory circuits 220(1)-220(N). The clock 228 may be controlled by the control circuit 214 and in particular may have an output clock signal adjusted up or down such as by adjusting a divide by M circuit 230 within the clock 228.

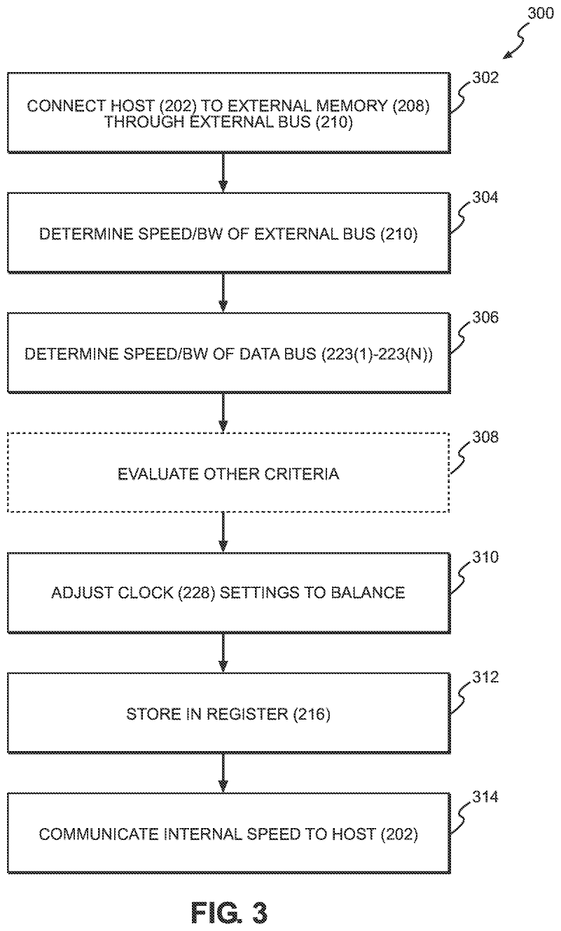

FIG. 3 illustrates a flowchart of a process 300 associated with balancing the buses 210 and 222. The process 300 begins when the host 202 is connected to an external memory 208 through an external bus 210 (block 302). The control circuit 214 determines the speed and/or bandwidth of the external bus 210 (block 304). This determination may be empirically determined, programmed into the persistent memory associated with the control circuit 214, or communicated to the control circuit 214 by the host 202. The control circuit 214 may also determine the native speed and/or bandwidth of the data bus 223(1)-223(N) (block 306). This determination may be empirically determined, programmed into the persistent memory, or the like. The control circuit 214 may optionally evaluate other criteria (block 308) such as power saving requirements or the like. Based on the determinations of the relative speeds of the buses 210, 222, the control circuit 214 adjusts the settings of the clock 228 to balance the speeds (block 310) such as by changing M in the divide by M circuit 230 of the clock 228. As noted, this adjustment may result in the overclocking of the memory circuits 220(1)-220(N) or underclocking to achieve the balancing.

With continued reference to FIG. 3, the control circuit 214 stores the new speed in the register 216 (block 312). This new internal speed is then communicated to the host 202 (block 314). Such communication may be proactive where the control circuit 214 actively sends the information after adjusting the clock 228, reactively, such as when the host 202 polls the register 216, or other technique as needed or desired.

While the above discussion has focused on a memory system that uses a PCIe bus and more particularly a CXL protocol over a PCIe bus, the present disclosure is not limited to such particular buses.

The systems and methods for balancing memory speeds, according to aspects disclosed herein, may be provided in or integrated into any processor-based device. Examples, without limitation, include a server, a desktop computer, a laptop computer, or the like, as well as more specialized processor-based devices such as a set-top box, an entertainment unit, a navigation device, a communications device, a fixed location data unit, a mobile location data unit, a global positioning system (GPS) device, a mobile phone, a cellular phone, a smartphone, a session initiation protocol (SIP) phone, a tablet, a phablet, a server, a computer, a portable computer, a mobile computing device, a wearable computing device (e.g., a smartwatch, a health or fitness tracker, eyewear, etc.), a personal digital assistant (PDA), a monitor, a computer monitor, a television, a tuner, a radio, a satellite radio, a music player, a digital music player, a portable music player, a digital video player, a video player, a digital video disc (DVD) player, a portable digital video player, an automobile, a vehicle component, avionics systems, or the like.

It is also noted that the operational steps described in any of the exemplary aspects herein are described to provide examples and discussion. The operations described may be performed in numerous different sequences other than the illustrated sequences. Furthermore, operations described in a single operational step may actually be performed in a number of different steps. Additionally, one or more operational steps discussed in the exemplary aspects may be combined. It is to be understood that the operational steps illustrated in the flowchart diagrams may be subject to numerous different modifications, as will be readily apparent to one of skill in the art. Those of skill in the art will also understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The previous description of the disclosure is provided to enable any person skilled in the art to make or use the disclosure. Various modifications to the disclosure will be readily apparent to those skilled in the art, and the generic principles defined herein may be applied to other variations. Thus, the disclosure is not intended to be limited to the examples and designs described herein but is to be accorded the widest scope consistent with the principles and novel features disclosed herein.

1. A memory device comprising:
an external bus interface configured to couple to a bus having a first speed;
an internal bus;
a memory circuit coupled to the internal bus and having a second speed;
a control circuit coupled to the internal bus and the external bus interface, the control circuit configured to:
compare the first speed to the second speed;
change the second speed to match approximately the first speed.

2. The memory device of claim 1, wherein the control circuit is configured to overclock the memory circuit to change the second speed to match the first speed.

3. The memory device of claim 1, wherein the control circuit is configured to change a divide by M circuit coupled to a clock to change the second speed to match the first speed.

4. The memory device of claim 1, wherein the control circuit is configured to slow down the second speed to match the first speed.

5. The memory device of claim 1, wherein the external bus interface comprises a peripheral component interconnect express (PCIe) bus interface or compute express link (CXL) enabled PCIe bus interface.

6. The memory device of claim 1, wherein the memory circuit comprises a dynamic random access memory (DRAM) memory circuit.

7. The memory device of claim 6, wherein the DRAM memory circuit comprises a double data rate (DDR) version 4 (DDR4) memory circuit.

8. The memory device of claim 1, further comprising a plurality of memory circuits.

9. The memory device of claim 1, further comprising a register coupled to the control circuit.

10. The memory device of claim 9, wherein the control circuit is configured to store the second speed in the register after changing the second speed to match the first speed.

11. A method of balancing speeds for a memory device, the method comprising:
determining a first speed associated with an external bus coupled to the memory device;
determining a second speed associated with a memory circuit in the memory device; and
changing the second speed to match approximately the first speed.

12. The method of claim 11, wherein changing the second speed comprises overclocking the memory circuit.

13. The method of claim 11, wherein changing the second speed to match the first speed comprises adjusting a divide by M circuit coupled to a clock.

14. The method of claim 11, wherein changing the second speed to match the first speed comprises slowing down the memory circuit.

15. The method of claim 11, further comprising storing the second speed in a register after changing the second speed to match the first speed.

16. The method of claim 15, further comprising providing the second speed from the register to a remote host after storing.

17. The method of claim 16, wherein providing the second speed comprises providing the second speed responsive to the remote host polling the register.
